(19) United States
(12) Patent Application Publication
(10) Pub. No.: US 2023/0087042 A1
(43) Pub. Date: Mar. 23, 2023

(54) GASKET FOR A BALL VALVE

(71) Applicant: A.V.V. ADDED VALUE FOR VALVES S.R.L., TELGATE(BG) (IT)

(72) Inventor: Gian Matteo SABEDDU, Torre De' Roveri (BG) (IT)

(21) Appl. No.: 17/790,425

(22) PCT Filed: Oct. 21, 2020
(86) PCT No.: PCT/IT2020/050254

§ 371 Date: Jun. 30, 2022

(30) Foreign Application Priority Data
Oct. 22, 2019 (IT) 102019000019496

(51) Int. Cl. F16K 5/06; F16K 25/00; F16K 27/06

(52) U.S. Cl. CPC F16K 5/0673; F16K 5/0689; F16K 25/005; F16K 27/067

(57) ABSTRACT

Disclosed is a gasket for a ball valve including: a valve body; a ball rotatable housed in the valve body; a first and a second seat positioned inside the valve body and housing the ball; and a seal of the type including a first and a second gasket interposed between the first and the second seat and the ball. Each gasket is a one-piece composite gasket and includes at least a first layer and a second layer made of thermoplastic materials, where the hardness, tensile strength and coefficient of friction values are different between the first and second layer, and where the first layer has lower values and coacts in a fluid-tight manner directly with the ball, while the second layer has higher values, normally acts as support for the first layer and coacts in a fluid-tight manner with the ball only upon reaching given operating conditions.

### TECHNICAL FIELD

The present invention is directed at the field of fluid handling in pressurized and low pressure circuits and concerns, in particular, a gasket for a ball valve, particularly of the trunnion ball type, adapted to connect two pipes and to allow, or shut off, the flow of a fluid therethrough.

### BACKGROUND ART

Ball valves are the most common and widely used type of device for shutting off a flow in hydraulic pipes.

Ball valves essentially comprise:

a valve body, adapted to couple with the pipes on which the valve is to be fitted;

a ball, provided with a cylindrical cavity coaxial to the flow, housed in the valve body so as to be able to rotate therein;

two seats, each provided with a shaped gasket, positioned inside said valve body and adapted to house said ball;

a lateral locking nut, adapted to clamp said valve body when the ball is inserted therein;

a stem, or control rod, adapted to coact directly with said ball;

an operating lever.

When the valve is in closed position, seal takes place through the contact between the ball and the shaped gaskets housed in the seats positioned inside the valve body. The ball is pivoted and guided by bushings mounted on the valve body. Ball valves of the trunnion ball type are particularly suitable for being controlled by means of actuators: seal is guaranteed by the piston effect of the actuator pushes the seat, and the related shaped gasket, against the ball, with springs that guarantee the preload required for engagement of the seal.

Gaskets currently used are made of elastomeric or thermoplastic materials, selected as a function of the specific application or of the operating conditions of the ball valve.

The more conventional solutions, for applications with standard operating pressure and temperature values and negligent chemical inertia, use elastomeric gaskets, for example rubber O-Rings, highly suitable from a mechanical point of view, as they are able to sustain noteworthy elastic deformation and return to their original size when the load is removed.

Alternatively, for applications requiring wider temperature ranges, thermoplastic gaskets are used.

Finally, for more extreme applications, such as valves in circuits with highly aggressive fluids from a chemical point of view, it is preferable not to use gaskets but to guarantee seal with direct metal-to-metal contact between the ball and the valve seats, following hardening treatment of the contact surfaces.

The sealing systems described above, whether of gasket or metal-to-metal type, have some limits and drawbacks.

The disadvantage of elastomeric gaskets is that they have a high torque, evident limits of resistance to low temperatures and high pressures, due to their very deformability, and chemical inertia in the presence of aggressive agents. Furthermore, elastomeric gaskets burn in conditions of high temperatures, or fires, in this way leaving the valve without seal means.

The disadvantage of thermoplastic gaskets is that they have low adaptability of the seal, as well as mechanical strength, chemical-physical strength and deformability which are easily influenced by temperatures and by operating pressures.

Moreover, if on the one hand thermoplastic gaskets are resistant to high temperatures, on the other they wear easily due to mutual rubbing with the metal parts with which they come into contact.

Finally, metal-to-metal gaskets require an increase in the size of the valve components (seats and ball), and higher costs due to the hardening treatments on the contact surfaces.

The document CN 103 982 674 A discloses a ball valve comprising gaskets between seats and ball with two layers: a first outer layer that in use comes into contact with the ball, made of a harder material such as NYLON or PEEK, and a second layer internal to the seat made of a softer material such as PTFE.

Gaskets thus produced do not operate correctly and cannot guarantee progressive seal of the valve: the harder material in contact with the ball seldom manages to adapt and offset any defects in the shape of the ball or wear, while the softer material inside the cavity of the seat is compressed and cannot provide the correct support for the entire gasket in the case of high pressures or temperatures.

### Presentation of the Invention

The object of the invention is to overcome these limits, by producing a gasket for a ball valve for pressurized or low pressure fluid circuits, of the trunnion ball type, which guarantees seal in any operating conditions, from high temperatures, to high or very low pressures, or in contact with particularly aggressive fluids and agents.

A further object of the invention is to produce a gasket that is not subject to premature wear, maintaining low production and maintenance costs of the valve that will house it.

The objects are achieved with a gasket for ball valve for connecting pipes in pressurized or low pressure fluid circuits, where said valve comprises:

a valve body;

a ball housed in the valve body so as to be able to rotate therein;

a first and a second seat positioned inside said valve body and adapted to house said ball;

seal means of the type comprising a first and a second gasket interposed between said first and said second seat and said ball;

where each gasket is characterized in that it is a one-piece composite gasket and comprises at least a first layer and a second layer made of thermoplastic materials, where the hardness, tensile strength and coefficient of friction values are different between said first and second layer, and where said first layer has lower values and coacts in a fluid-tight manner directly with said ball, while said second layer has higher values, normally acts as support for said first layer and coacts in a fluid-tight manner with said ball only upon reaching given operating conditions.

According to a first aspect of the invention, said first layer is selected from thermoplastic materials having the following properties:
hardness >55 Sh D
tensile strength >25 MPa
coefficient of friction between 0.06-0.1 (ASTM D 1894).

Advantageously, said first layer is selected from PTFE and its derivatives.

In a preferred variant, said first layer comprises a virgin or modified PTFE, strengthened with the addition of graphite.

Even more preferably, said first layer comprises a virgin or modified PTFE, strengthened with the addition of carbon.

According to a further aspect of the invention, said second layer is selected from thermoplastic materials having the following properties:
hardness >75 Sh D
tensile strength >45 MPa
coefficient of friction between 0.25-0.35 (ASTM D 1894).

Advantageously, said second layer is selected from PEEK or PCTFE.

According to a possible variant of embodiment, said first layer and said second layer are structured respectively by means of a first and a second ring permanently joined to each other.

In particular, said first ring comprises a protrusion produced on its outer edge.

According to possible variants of embodiment, said first ring is alternatively facing the inside or the outside of said ball valve.

Alternatively, said second ring comprises a central annular recess and said first ring engages said central annular recess.

In a further possible variant, said second ring comprises an annular cut-out and said first ring is inserted into said annular cut-out.

The advantages of the invention are evident, due to the simultaneous use of two different materials having physical-mechanical properties capable of guaranteeing maximum seal of the valve in any operating condition.

Although the gasket is composed of two layers of different thermoplastic materials, it acts as a single one-piece component.

The seal guaranteed by the gasket is a progressive seal, which uses the capacity to adapt and slide of the softer material forming the first layer, as well as the physical-mechanical support of the harder material forming the second layer.

Advantageously, the more adaptable material, i.e., the PTFE or a derivative thereof, will offset the errors of shape caused by the deformations in valve (due either to errors of execution of the components, for example problems of roundness occurring during production or elastic deformations of the components under pressure), while the harder material, whether PEEK or PCTFE, will support the adaptable part of the seal, and will provide, in the case of wear or plastic deformation of the first softer layer, for example upon reaching a given operating pressure, a safe seal.

Although maintaining the same advantages as elastomeric seals and hence optimum adaptability and perfect seal at low pressure, with the combination of the materials selected for the two layers, the gasket is also able to operate in a wide temperature range (from cryogenic to high temperatures) and with maximum chemical inertia.

Moreover, through the appropriate combination of size and positioning of the two rings and selection of materials with low coefficient of friction, it is possible to guarantee a considerable decrease in torque with respect to conventional solutions.

### BRIEF DESCRIPTION OF THE DRAWINGS

These and other advantages will be more evident below, in the description of preferred embodiments of the invention provided by way of non-limiting example, and with the aid of the figures, wherein:

FIG. 1 represents a portion of a ball valve for pressurized fluid circuits, sectioned along a longitudinal plane, comprising two gaskets according to the invention;

FIGS. 2, 3 and 4 represent, in detail section views, a composite gasket according to three possible variants of the invention, housed in a seat of a ball valve for pressurized fluid circuits.

### DETAILED DESCRIPTION OF PREFERRED EMBODIMENTS OF THE INVENTION

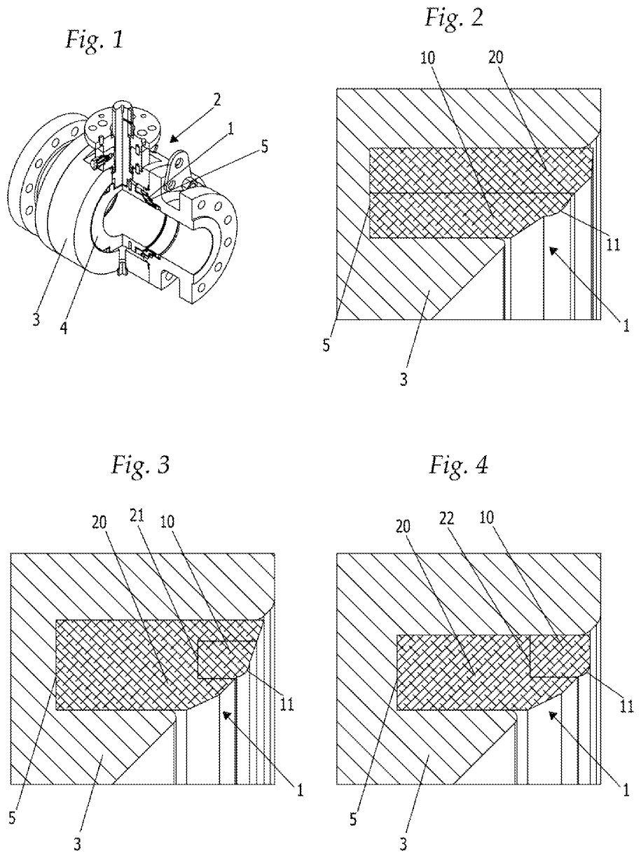

With reference to FIG. 1 there is shown a portion of ball valve 2 for pressurized or low pressure fluid circuits substantially comprising

a valve body 3, adapted to couple with a first pipe upstream and a second pipe downstream (not illustrated) to which the valve 2 is to be fitted;

a ball 4 provided with a cylindrical cavity coaxial to the flow of the fluid, housed in the valve body 3 so as to be able to rotate therein;

a first and a second seat 5 positioned inside said valve body 3, coaxial to said pipes, and adapted to house said ball 4 with interposition of respective first and second gaskets 1.

With particular reference to the details of FIGS. 2-4, said gaskets 1 are illustrated according to possible variants of embodiment of the invention.

Said gaskets 1 are of composite type, produced by means of a first 10 and a second 20 layer of different materials, structured substantially in a ring.

The materials selected are all thermoplastic polymers, but have different physical-mechanical properties to one another.

A first layer 10 coacts in a fluid-tight manner with said ball 4, while a second layer 20 acts as support for said first layer 10 and coacts in a fluid-tight manner with said ball 4 upon reaching given operating conditions, for example a given high pressure value, i.e., when a predetermine pressure threshold is exceeded or upon reaching given conditions of wear of the gasket.

Said first layer 10, the softer and more flexible of the two, is selected from thermoplastic materials having the following properties:

hardness >55 Sh D

tensile strength >25 MPa

coefficient of friction between 0.06-0.1 (ASTM D 1894).

A thermoplastic material having these properties is polytetrafluoroethylene (PTFE), better known by its trade names: Teflon, Fluon, Algoflon, Hostaflon, Inoflon.

This polymer can be used virgin or with the addition of other stabilizing and fluidifying components to improve its application possibilities or fillers based on silica, carbon, graphite, bronze, stainless steel, exd, to increase the mechanical, pneumatic or chemical performances.

For the application of the present invention, excellent results were obtained with a virgin PTFE having the following properties:

VIRGIN PTFE

| | Unit of | | | |
|---|---|---|---|---|
| | measurement | Test | Value | Tolerance |
| Physical properties | | | | |
| Specific weight | g/cm³ | ISO 1183 | 2.3 | — |
| Water absorption | % | ISO 62 | 0.01 | — |
| (23° C./73° F.) | | | | |
| Equilibrium water | % | ISO 62 | — | — |
| absorption (23° C./73° F.) | | | | |
| Mechanical properties | | | | |
| Hardness | ShD | ASTM | >55 | +/−3 |
| | | D1894 | | |
| Ultimate tensile strength | Mpa | ASTM | 24.82 | +/−0.03 |
| | | D638 tV | | |
| Tensile elongation at | % | ASTM | 248 | — |
| break | | D638 tV | | |
| Coefficient of friction | Mpa | ASTM | 0.06 | — |
| | | D1894 | | |
| Coefficient of wear | 10E−8 | — | — | — |
| | (Mpa)(m/min)h | | | |
| Charpy pendulum impact | J/m | ASTM | 145 | |
| test (23° C./73° F.) | | D256 | | |
| Thermal properties | | | | |
| Operating temperature | ° C. | — | −200/200 | — |
| | | | (220 short term) | |
| Thermal conductivity | W m−¹ ° C.⁻¹ | ASTM | — | — |
| | | C177 | | |
| Heat deflection | ° C. | ISO 75 at | 49 | — |
| temperature | | 1.8 Mpa | | |
| AVG coeff. of linear | 10E⁻⁵ ° C.⁻¹ | ASTM | 1.2 | — |
| expansion below TG | | D696 | | |
| Flammability | ° C. | UL 94 | V-0 | — |
| Melting point | ° C. | DSC | 327 | — |
| Glass transition (TG) | ° C. | DSC | −75 | — |
| Other properties | | | | |
| Tensile modulus | Mpa | DIN | 560 | — |
| | | 53457 | | |

Even better results are obtained with a PTFE modified with the addition of 25% carbon, having the following properties:

RPTFE (25% Carbon)

| | Unit of | | | |
|---|---|---|---|---|
| | measurement | Test | Value | Tolerance |
| Physical properties | | | | |
| Specific weight | g/cm³ | ISO 1183 | 2.1 | — |
| Water absorption | % | ISO 62 | 0.03 | — |
| (23° C./73° F.) | | | | |
| Equilibrium water | % | ISO 62 | — | — |
| absorption (23° C./73° F.) | | | | |
| Mechanical properties | | | | |
| Hardness | ShD | ASTM | >62 | +/−3 |
| | | D1894 | | |
| Ultimate tensile strength | Mpa | ASTM | 13 | +/−0.03 |
| | | D638 tV | | |
| Tensile elongation at | % | ASTM | 70 | — |
| break | | D638 tV | | |
| Coefficient of friction | Mpa | ASTM | 0.12 | — |
| | | D1894 | | |
| Coefficient of wear | 10E−8 | — | — | — |
| | (Mpa)(m/min)h | | | |
| Charpy pendulum impact | J/m | ASTM | 140 | |
| test (23° C./73° F.) | | D256 | | |
| Thermal properties | | | | |
| Operating temperature | ° C. | — | −200/200 | — |
| | | | (250 short term) | |
| Thermal conductivity | W m−¹ ° C.⁻¹ | ASTM | 0.59 | — |
| | | C177 | | |
| Heat deflection | ° C. | ISO 75 at | — | — |
| temperature | | 1.8 Mpa | | |
| AVG coeff. of linear | 10E⁻⁵ ° C.⁻¹ | ASTM | 1.15 | — |
| expansion below TG | | D696 | | |
| Flammability | ° C. | UL 94 | V-0 | — |
| Melting point | ° C. | DSC | 320 | — |
| Glass transition (TG) | ° C. | DSC | — | — |
| Other properties | | | | |
| Tensile modulus | Mpa | ASTM | 1000 | — |
| | | D412 | | |
| Compression stress | Mpa | ASTM | 8 | — |
| | | D695 | | |

Said second harder layer 20 having the function of support, is selected from thermoplastic materials having the following properties:

hardness >75 Sh D

tensile strength >45 MPa

coefficient of friction between 0.25-0.35 (ASTM D 1894).

Thermoplastic materials with these properties are polyether ether ketone (PEEK) and the polychlorotrifluoroethylene (PCTFE), to be selected based on the different needs and applications.

In detail, PEEK has the following mechanical properties:

hardness >85 Sh D

tensile strength >100 MPa

coefficient of friction between 0.25-0.30 (ASTM D 1894).

For the application of the present invention, excellent results were obtained with a virgin PEEK having the following properties:

VIRGIN PEEK

| | Unit of | | | |
|---|---|---|---|---|
| | measurement | Test | Value | Tolerance |
| Physical properties | | | | |
| Specific weight | g/cm³ | ISO 1183 | 1.3 | — |
| Water absorption | % | ISO 62 | 0.05 | — |
| (23° C./73° F.) | | | | |
| Equilibrium water | % | ISO 62 | 0.5 | — |
| absorption (23° C./73° F.) | | | | |
| Mechanical properties | | | | |
| Hardness | ShD | ASTM | >84.5 | +/−3 |
| | | D1894 | | |
| Ultimate tensile strength | Mpa | ASTM | 100 | +/−0.03 |
| | | D638 tV | | |
| Tensile elongation at | % | ASTM | 34 | — |
| break | | D638 tV | | |
| Coefficient of friction | Mpa | ASTM | 0.34 | — |
| | | D1894 | | |
| Coefficient of wear | 10E−8 | — | 1.44 | — |
| | (Mpa)(m/min)h | | | |
| Charpy pendulum impact | KJ m⁻² | ASTM | 7 | |
| test (23° C./73° F.) | | D6110/ | | |
| | | ISO 179-1 | | |
| Thermal properties | | | | |
| Operating temperature | ° C. | — | −100/250 | — |
| | | | (310 short term) | |
| Thermal conductivity | W m−¹ ° C.⁻¹ | ASTM | 0.25 | — |
| | | C177 | | |
| Heat deflection | ° C. | ISO 75 at | 152 | — |
| temperature | | 1.8 Mpa | | |
| AVG coeff. of linear | 10E⁻⁵ ° C.⁻¹ | ASTM | 4.7 | — |
| expansion below TG | | D696 | | |
| Flammability | ° C. | UL 94 | V-0 | — |
| Melting point | ° C. | DSC | 343 | — |
| Glass transition (TG) | ° C. | DSC | 143 | — |
| Other properties | | | | |
| Electrical conductivity | ohm om | ASTM | 1E⁻¹⁷ | — |
| | | D257 | | |
| Tensile modulus | Gpa | ASTM | 3.5 | — |
| | | D638 tV | | |
| Compression stress | Mpa | ASTM | 119 | — |
| | | D695 | | |
| Izod impact strength test | J m⁻¹ | ASTM | 94 | — |
| (0.25 mm 23° C./73° F.) | | D256 | | |

Instead, PCTFE has the following mechanical properties:

hardness >75 Sh D

tensile strength >45 MPa

coefficient of friction between 0.3-0.35 (ASTM D 1894).

Excellent results were obtained with a PCTFE having the following properties:

PCTFE

| | Unit of | | | |
|---|---|---|---|---|
| | measurement | Test | Value | Tolerance |
| Physical properties | | | | |
| Specific weight | g/cm³ | ISO 1183 | 2.1 | — |
| Water absorption | % | ISO 62 | 0 | — |
| (23° C./73° F.) | | | | |
| Equilibrium water | % | ISO 62 | 0 | — |
| absorption (23° C./73° F.) | | | | |
| Mechanical properties | | | | |
| Hardness | ShD | ASTM | >75 | +/−3 |
| | | D1894 | | |
| Ultimate tensile strength | Mpa | ASTM | 40 | +/−0.03 |
| | | D638 tV | | |
| Tensile elongation at | % | ASTM | 150 | — |
| break | | D638 tV | | |
| Coefficient of friction | Mpa | ASTM | — | — |
| | | D1894 | | |
| Coefficient of wear | 10E−8 | — | — | — |
| | (Mpa)(m/min)h | | | |
| Charpy pendulum impact | KJ m⁻² | ASTM | — | |
| test (23° C./73° F.) | | D6110/ | | |
| | | ISO 179-1 | | |
| Thermal properties | | | | |
| Operating temperature | ° C. | — | −2507150 | — |
| Thermal conductivity | W m−¹ ° C.⁻¹ | ASTM | — | — |
| | | C177 | | |
| Heat deflection | ° C. | ISO 75 at | — | — |
| temperature | | 1.8 Mpa | | |
| AVG coeff. of linear | 10E⁻⁵ ° C.⁻¹ | ASTM | — | — |
| expansion below TG | | D696 | | |
| Flammability | ° C. | UL 94 | V-0 | — |
| Melting point | ° C. | DSC | 210 | — |
| Glass transition (TG) | ° C. | DSC | — | — |

As already stated above, with the correct combination of the materials selected for the two layers, the gasket 1 is also suitable to operate in a wide temperature range (from cryogenic to high temperatures) and with maximum chemical inertia.

Purely by way of example, the tests showed that:

the combination PTFE-PEEK is optimal for high pressure applications up to 420 bar with temperatures from −100° C. to 220° C.;

the combination PTFE-PCTFE is optimal for medium/high pressure applications up to 250 bar with temperatures from −196° C. to 150° C.

With particular reference to the geometry of said gasket 1, in all the possible variants of embodiment said first layer 10 and said second layer 20 are structured respectively by means of a first and a second ring permanently joined to each other to form a single piece.

As said soft and flexible first layer 10 made of PTFE is adapted to coact in a fluid-tight manner first with said ball 4, said first ring comprises a protrusion 11 produced on its outer edge.

The greater the elastic springback of the PTFE used is, the more this protrusion 11 protrudes: this protrusion 11 must be sufficient to offset the deformation compression sustained by said first ring subjected to the pressure of the ball 4.

With reference to FIG. 2, said first and said second ring are permanently joined to each other by co-moulding and said first layer 10 made of softer and more flexible material is facing the inside of the ball valve 2.

With reference to FIG. 3, said second ring of the layer 20 made of harder material substantially occupies the whole of the seat 5 and has a central annular recess 21, open along its outer edge, into which said first layer 10 made of PTFE is inserted by interference, with mechanical bonding.

With reference to FIG. 4, said second layer 20 made of harder material produced by said second ring also substantially occupies the whole of the seat 5, but has an annular cut-out 22 arranged along its free edge at its corner more external to the valve 2. Said ring-shaped first layer 10 made of PTFE is provided in this annular cut-out 22, fixed by means of chemical bonding.

Operation of the composite gasket 1 is described below.

When the valve 2 is in closed position, the seal is obtained through contact between the ball 4 and the gasket 1.

This is a progressive seal, which uses the capacity to adapt and slide of said first layer 10 made of PTFE as soft and flexible material, and the mechanical physical support of said second layer 20 made of PEEK or PCTFE as harder material.

It is clear that in conditions of low pressure in the first instance the first layer 10 made of softer material that deforms and also absorbs the construction “defects” of the valve resists, while at high pressures and in conditions of wear of the gasket, said second layer 20 also provides a seal.

1) A gasket for a ball valve for connecting pipes in pressurized or low pressure fluid circuits, where said ball valve comprises:
a valve body;
a ball housed in the valve body so as to be able to rotate therein;
a first and a second seat positioned inside said valve body and adapted to house said ball;
sealing means of the type comprising a first and a second gasket interposed between said first and said second seat and said ball;
where each gasket is a one-piece composite gasket and comprises at least a first layer and a second layer made of thermoplastic materials, where the hardness, tensile strength and coefficient of friction values between said first and second layer are different, and where said first layer has lower values and coacts in a fluid-tight manner directly with said ball, while said second layer has higher values, normally acts as support for said first layer and coacts in a fluid-tight manner with said ball only upon reaching given operating conditions.

2) The gasket according to claim 1, wherein said first layer is selected from thermoplastic materials having the following properties:
hardness >55 Sh D
tensile strength >25 MPa
coefficient of friction between 0.06-0.1, per ASTM D 1894.

3) The gasket according to claim 2, wherein said first layer is selected from PTFE and its derivatives.

4) The gasket according to claim 3, wherein said first layer comprises a virgin or modified PTFE, strengthened by adding graphite.

5) The gasket according to claim 4, wherein said first layer comprises a virgin or modified PTFE, strengthened by adding carbon.

6) The gasket according to claim 1, wherein said second layer is selected from thermoplastic materials having the following properties:
hardness >75 Sh D
tensile strength >45 MPa
coefficient of friction between 0.25-0.35, per ASTM D 1894.

7) The gasket according to claim 2, wherein said second layer is selected from PEEK or PCTFE.

8) The gasket according to claim 1, wherein said first layer and said second layer are structured respectively by means of a first and a second ring permanently joined to each other.

9) The gasket according to claim 8, wherein said first ring comprises a protrusion produced on its outer edge.

10) The gasket according to claim 8, wherein said first ring is alternatively facing the inside or the outside of said valve.

11) The gasket according to claim 8, wherein said second ring comprises a central annular recess and said first ring is inserted into said central annular recess.

12) The gasket according to claim 8, wherein said second ring comprises an annular cut-out and said first ring is inserted into said annular cut-out.

13) A ball valve comprising at least a gasket according to at least claim 1.

14) A ball valve comprising at least a gasket according to at least claim 2.

15) A ball valve comprising at least a gasket according to at least claim 3.

16) A ball valve comprising at least a gasket according to at least claim 4.

17) A ball valve comprising at least a gasket according to at least claim 5.

18) A ball valve comprising at least a gasket according to at least claim 6.

19) A ball valve comprising at least a gasket according to at least claim 7.

20) A ball valve comprising at least a gasket according to at least claim 8.
